(19) United States
(12) Patent Application Publication
(10) Pub. No.: US 2013/0001142 A1
(43) Pub. Date: Jan. 3, 2013

(54) ADVANCED CONTROL SYSTEM FOR WASTEWATER TREATMENT PLANTS WITH MEMBRANE BIOREACTORS

(76) Inventors: Richard A. Novak, Naperville, IL (US); Monica de Gracia, San Sebastian (Gipuzkoa) (ES); Andoni Urruticoechea, Pasaia (Gipuzkoa) (ES); Asun Larrea, Tolosa (Gipuzkoa) (ES); John F. Billingham, Getzville, NY (US)

(21) Appl. No.: 13/494,528

(22) Filed: Jun. 12, 2012

Related U.S. Application Data
(60) Provisional application No. 61/496,275, filed on Jun. 13, 2011.

(51) Int. Cl. C02F 3/00; B01D 65/02; B01D 61/00

(52) U.S. Cl. 210/96.2

(57) ABSTRACT

An advanced control system for a membrane bioreactor based wastewater treatment plant is disclosed. The disclosed control system comprises a membrane bioreactor (MBR) system and a microprocessor based controller that receives signals corresponding to selected measured MBR parameters and calculates or estimates one or more MBR calculated parameters including Membrane Conductivity (Fxc); and/or Oxygen Uptake Rate (OUR). The microprocessor based controller compares one or more calculated or estimated MBR parameters to prescribed setpoints or desired ranges and governs one or more pumps and valves in the MBR system to adjust the cleaning cycle the MBR system, the MBR flows in the MBR system, or the influent flow to the biological basin in response thereto.

### CROSS REFERENCE TO RELATED APPLICATIONS

The present application claims priority from U.S. provisional patent application Ser. No. 61/496,275 filed Jun. 13, 2011, the disclosure of which is incorporated fey reference herein.

### FIELD OF THE INVENTION

The present invention relates to control strategies for wastewater treatment plants with membrane bioreactors (MBR) systems and, more particularly, to advanced wastewater treatment control strategies for the MBR systems in the wastewater treatment plant that uses the Oxygen Uptake Rate, Membrane Conductivity or other calculated MBR parameters to control the operation of the MBR system.

### BACKGROUND

Membrane bioreactors combine membrane filtering technology and activated sludge biodegradation processes for the treatment of wastewater. In a typical MBR system, immersed or external membranes are used to filter an activated sludge stream from a bioreactor to produce a high quality effluent, as generally described for example, in U.S. Pat. Nos. 7,879,229 and 8,114,293.

MBR systems used in wastewater treatment systems are typically designed or sized to deliver a targeted, permeate output or effluent. In immersed membrane bioreactor systems, the membrane filter is immersed in an open tank containing the wastewater sludge stream to be filtered. Filtration is achieved by drawing water through the membranes under a vacuum. The transmembrane pressure, or pressure differential across the membrane, causes the water to permeate through the membrane walls. The filtered water or permeate is typically transferred to a downstream tank, reservoir or receiving stream. The suspended solids and other materials that do not pass through the membrane walls are recycled or discharged for further treatment depending on the MBR system design. Air scouring is typically used to clean the surfaces of the immersed membranes by delivering a stream of air or gas bubbles under or sear the bottom of the membrane filters. The rising air or gas bubbles scour the membrane surfaces to reduce fouling and maintain the desired or targeted permeation rate.

The targeted permeate output of an MBR system often varies based on a number of factors including for example, changes in influent volume, influent characterization, as well as other external factors such as time of day and seasonal or weather conditions. To achieve the targeted permeate output, the conventional means to control the MBR system, is to control the transmembrane pressure. To control the transmembrane pressure, many existing control systems for immersed MBR systems control the vacuum pressure as well as intensity and/or frequency of the air scorning process applied, to the surface of the immersed membranes. Since the air scouring process is often, performed on a cyclical or intermittent basis, adjusting the frequency of membrane cleaning involves altering the timing or pulsing of the air scouring process. On the other hand, adjusting the intensity of the air scouring process involves either increasing the aeration rate, expressed in m³ of air per m² of membrane area, or adjusting the duration of the air scouring. Note however, that energy is required, to provide this air scouring which is a significant contributor to the overall energy consumption and operating costs of the MBR system.

One example of an MBR control system is disclosed in European Patent publication EP2314368. This prior art MBR control system generally controls the cycling between various membrane cleaning processes/regimes and the basic membrane operating process, referred to as the permeation regime. The prior art MBR control system uses measured or calculated, process information, and in particular the ‘resistance in series’ parameter of the MBR system to optimize one or more process operating parameters and improve MBR system, performance or reduce MBR system operating costs. In addition to the permeate flux, the other controlled operating parameters that are adjusted in the prior an MBR control system are ail membrane cleaning based parameters including: (a) aeration frequency factor; (b) aeration flow; (c) backwash flow/duration; (d) relaxation duration; (e) permeation duration; or (f) chemical cleaning frequency.

While this prior art control system is effective in controlling a membrane cleaning process, it does little to control or optimize the flows within the MBR system or the overall wastewater treatment process. What is needed therefore, is an advanced control system that reliably and automatically controls performance of MBR system within a wastewater treatment plant based, in part, on membrane performance characteristics such as Membrane Conductivity in conjunction with other calculated MBR parameters and/or on the Oxygen Uptake Rate in the aeration basin or other biological system parameters.

### SUMMARY OF THE INVENTION

The present invention may be broadly characterized as an advanced control system for MBR based wastewater treatment plants comprising: (i) a membrane bioreactor (MBR) system; (ii) one or more microprocessor based controllers that receives signals corresponding to selected measured MBR parameters and calculates one or more MBR calculated parameters including Oxygen Uptake Rate (OUR) in an upstream biological basin or Membrane Conductivity (Fxc); and (iii) wherein the microprocessor based controller(s) compares one or more calculated MBR parameters to prescribed setpoints or desired ranges and governs the one or more pumps and the one or more valves in the MBR system to adjust the MBR measured parameters in response thereto.

The MBR system preferably comprises a plurality of MBR conduits, one or more membrane modules; one or more pumps for moving wastewater through the MBR conduits or tanks; one or more valves for controlling the flows through the MBR conduits or tanks; and a plurality of sensors adapted for measuring or ascertaining one or more of the prescribed MBR measured parameters selected from the group consisting of; temperature of the stream flowing into the membrane; the flow rate of the stream into the membrane; the flow rate of the sludge stream out of the membrane; the flow rate of the permeate stream out of membrane; pressure of the flow into the membrane; pressure of the flow out of the membrane; the pressure of the permeate flow out of the membrane. In the case of external or cross-flow membranes (e.g. pressurized MBR), the bulk fluid flow through the membrane conduits provide the energy needed to keep the membranes clear of solids. In the case of immersed or low-pressure membranes, in addition to the above parameters there are measures associated with other means of keeping the membranes clear of solids, such as scouring air flow, pumped fluid flow, or mechanical mixing means.

The present invention may also be characterized as an advanced control system for an MBR based wastewater treatment plant comprising: (i) an aeration basin; (ii) an MBR system comprising a plurality of MBR conduits, one or more membrane modules; one or more pumps for moving wastewater through the MBR conduits; one or more valves for controlling the flows through the MBR conduits; and (iii) one or more microprocessor based controllers that receives signals from a plurality of sensors associated with the aeration basin including a dissolved oxygen (DO), probe and calculates or estimates the Oxygen Uptake Rate (OUR) in the aeration basin. The microprocessor based controller(s) compares the OUR to desired ranges and makes appropriate control actions, as for example controlling one or more pumps and the one or more valves in the MBR system to adjust the MBR flows and associated performance of the MBR system in response thereto.

Finally, the present invention may also be characterised as n advanced control system for a wastewater treatment plant comprising: a membrane bioreactor (MBR) system comprising a plurality of membrane modules or units; one or more pumps and valves for controlling the flow of wastewater through the membrane modules or units; and a plurality of sensors for measuring one or more of MBR measured parameters; and one or more microprocessor based controllers that: (i) receives signals corresponding to the measured MBR parameters from the plurality of sensors; (ii) calculates Membrane Conductivity (Fxc); (iv) compares the calculated membrane conductivity (Fxc) to prescribed setpoints; and (iv) initiates a membrane cleaning cycle when membrane conductivity falls below minimum setpoint. The measured parameters include temperature of the stream, flowing into the membrane modules or units; the flow rate of the stream into the membrane modules or units; the flow rate of the sludge stream out of the membrane modules or units; the flow rate of the permeate stream out of membrane modules or units; pressure of the flow into the membrane modules or units; pressure of the flow out of the membrane modules or units; the pressure of the permeate flow out of the membrane modules or units.

### BRIEF DESCRIPTION OF THE DRAWINGS

The above and other aspects, features, and advantages of the present invention will be more apparent from tire following, more detailed description thereof presented in conjunction with the following drawings, wherein:

FIG. 1 is a schematic representation of a wastewater treatment operation with an external membrane bioreactor (eMBR) system adapted to employ or use the present control systems; and

FIG. 2 is a schematic representation a wastewater treatment operation with an immersed membrane bioreactor (iMBR) system adapted to employ or use the present control systems.

### DETAILED DESCRIPTION

### Wastewater Treatment Plant Parameters and Measurement Techniques

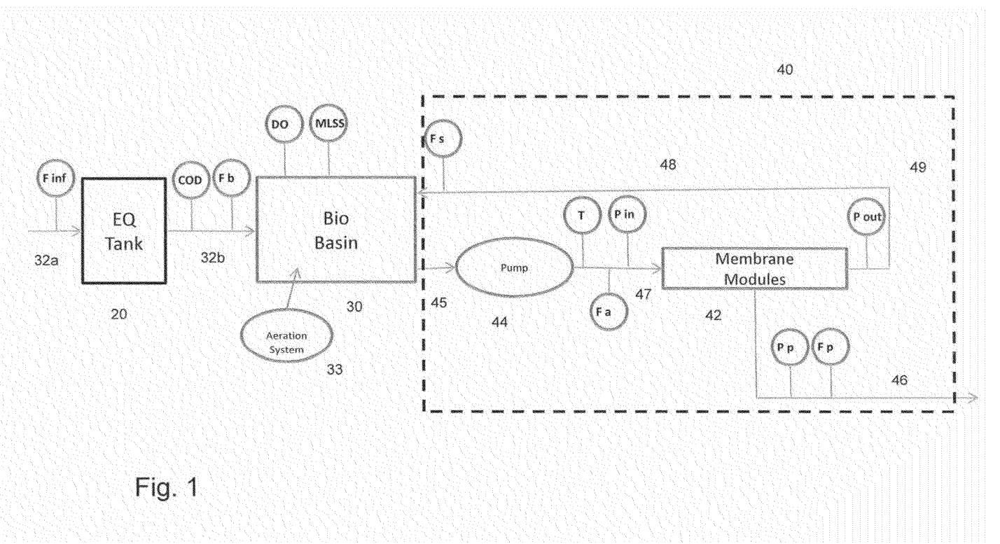

Turning to FIG. 1, there is shown a high level schematic representation of the biological systems within a wastewater treatment plant having an external membrane bioreactor (eMBR) system. FIG. 1 shows a simplified representation of an activated sludge process employing an equalization tank 20 feeding wastewater into an aeration or biological basis 30, an aeration system 33 to inject high purity oxygen (HPG) or air into the aeration basin, and an membrane bioreactor (MBR) system 40 including a plurality of membrane modules 42, a MBR pump 44, a MBR intake conduit 46, and a recycle conduit 48. The illustrated system, includes an influent stream 32a, 32b directed to the equalization tank 20 and then to the biological basin 30. A portion of the wastewater in the biological basin 30 is diverted as an MBR stream 45 via the MBR pump 44 to the membrane modules 42. The sludge stream 49 exiting the MBR system 40 is recycled back to the biological basin 30 while the permeate stream 46 exiting the MBR system 40 represents the treated effluent. Also shown in FIG. 1 are the MBR based wastewater treatment system parameters that are measured at selected locations within the illustrated system and used in the present control system (not shown). Descriptions of these parameters and the preferred sensing or measurement means are provided in Table 1.

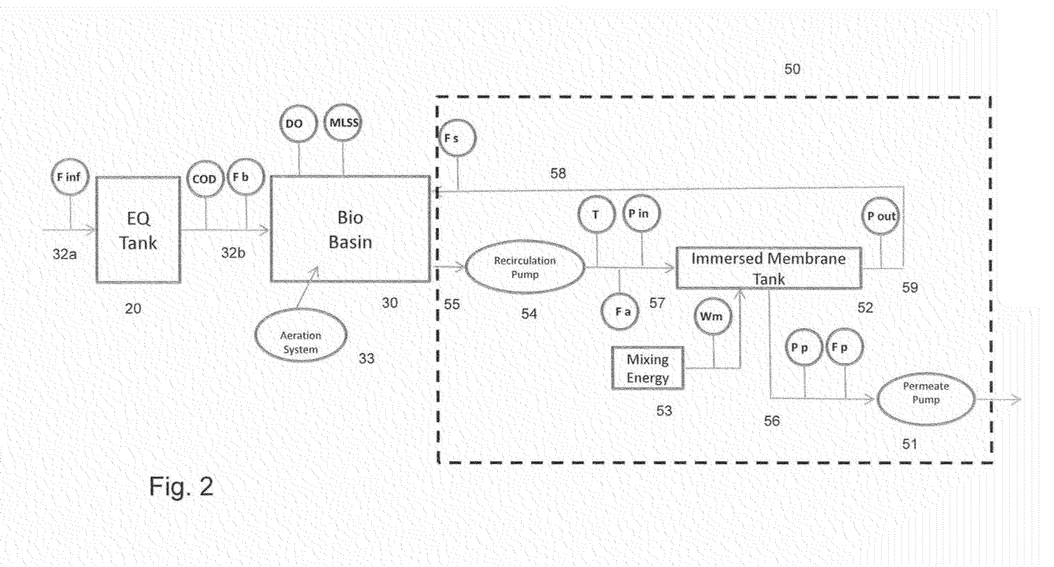

Turning to FIG. 2, there is shown another high level schematic representation of a wastewater treatment plant employing an immersed membrane bioreactor (iMBR) system. FIG. 2 shows influent received by an equalization tank 20 and feeding the wastewater into an aeration basin 30, which optionally is coupled to an aeration system 33 to inject high parity oxygen (HPO) or air into the aeration or biological basin. The immersed membrane bioreactor (iMBR) system 50 includes an immersed membrane tank 52, a means for mixing 53 or agitating the membrane tank 52, an iMBR recirculation pump 54, an iMBR intake conduit 57, and a recycle conduit 58. The influent stream 32a, 32b is directed to the equalization tank 20 and then to the biological basin 30. A portion of the wastewater in the biological basin 30 is diverted as an iMBR stream 55 via the iMBR recirculation pump 54 to the membrane tank 52 where one or more iMBR units (e.g. membrane units) are immersed. The sludge stream 59 exiting the iMBR tank 52 is recycled back to the biological basin 30 while the permeate stream 56 pulled from the iMBR tank 52 via the permeate pump 51 represents the treated effluent. Also shown are the MBR based wastewater treatment system parameters that are measured at selected locations within the illustrated system and used in the present control system (not shown).

TABLE 1
MBR System Control Parameters

| Parameter | Description | Measurement/Calculation |
|---|---|---|
| OUR | Oxygen Uptake Rate | Calculated or Estimated from system data |
| DO | Dissolved Oxygen Level | Measured using DO probe |
| MLSS | Mixed Liquor Suspended Solids | Measured using optical probes |
| F_{inf} | Flow Rate of Influent to Equalization tank | Measured using flow meters |
| F_{b} | Flow rate to biological basin | Measured using flow meters |
| Fₛ | Sludge Flow Rate out of Membrane | Calculated from pump flow or measured |
| Fₐ | Sludge Flow Rate into Membrane | Calculated from pump flow or measured |
| Pᵢₙ | Pressure of sludge flow into Membrane | Measured using pressure transducers |
| Pₒᵤₜ | Pressure of sludge flow out of Membrane | Measured using pressure transducers |
| Pₚ | Pressure of permeate flow out of Membrane | Measured using pressure transducers |
| Fₚ | Flow rate of permeate out of Membrane | Calculated from pump flow or measured |
| T | Temperature of Flow into Membrane | Measured using temperature sensors |
| M-Area | Membrane Area | Fixed parameter based on WWT Plant Design |
| TMP | Trans Membrane Pressure | Calculated based on measured pressures |
| Fx | MBR Flux | Calculated based on Permeate Flow Rate |
| Kt | Temperature Correction Coefficient | Estimated or calculated based on Temperature |
| Fxc | Membrane System Conductivity | Calculated based on Fx, Kt and TMP |
| CFP | Cross-Flow Pressure Drop | Calculated based on measured pressures |

The flews within the illustrated systems in FIGS. 1 and 2 are monitored and controlled, via the illustrated, pumps as well as a plurality of control valves (not shown) disposed in the various conduits operatively coupled to a microprocessor based controller. The control valves are controlled by opening and closing, as needed, to maintain the appropriate flows and pressures of the streams and proper operating conditions within the MBR system in response to the measured and calculated parameters described in more detail below.

MBR Based Monitoring & Control

In one of the more conventional embodiments of the present control system, the flow rates into and out of the MBR are measured together with the permeate flow rate and input to a microprocessor based controller which employs a control strategy to change the pump flow rates and settings for any backpressure valves to maintain the MBR flow rates within the desired or prescribed ranges. Pump flow rates may include the pump to the MBR system as well as any recycle pump within the MBR system. The desired or prescribed flow rates out of the MBR are typically preset design parameters matched to the expected or actual influent flow. Changes or adjustments in the pump flow rates and backpressure valves also affect the MBR pressures. Thus, controlling the pump flow rate and back pressure valves, the flows into and out of the MBR as well as the pressures associated with the MBR will be controlled collectively. Specifically, the flow rate of the sludge into the MBR is compared to the desired or prescribed range of acceptable flow rates. If the measured flow rate of sludge into the MBR is too high, the energy use and associated costs of energy will increase and the MBR system performance will suffer due to erosion and membrane fouling. If the measured flow rate of sludge into the MBR is too low, the MBR system performance will also suffer due to decreased membrane efficiency.

In other conventional embodiments of the present control system the pressures of the sludge flow in and out of the membrane and the pressure of the permeate flow out of the membrane are measured and the Trans Membrane Pressure (TMP) and Cross Flow Pressure Drop (CFP) are calculated as set forth below:

TMP=[(Pᵢₙ+Pₒᵤₜ)/2]−Pₚₑᵣₘ (1)

CFP=[Pᵢₙ+Pₒᵤₜ] (2)

The Trans Membrane Pressure (TMP) is then compared against a prescribed setpoint or range. It the calculated IMP value is above a higher limit setpoint or prescribed range, a control system alarm is produced indicating fee MBR system may be clogged. Also, if the calculated TMP value is below a lower limit setpoint or prescribed range, another control system alarm is produced indicating the MBR system may be experiencing physical or control problems. Excessively high or low values of the calculated TMP may also be indicative of possible existence of extra cellular substances which may cause the system operator or the present control system, to initiate other system control actions.

Similarly, the CFP is also compared against a prescribed setpoint or range. As with the TMP control strategy, if the calculated CFP value is above a higher limit setpoint or prescribed range, a control system alarm is produced indicating the MBR system may be clogged. Also, if the calculated CFP value is below a lower limit setpoint or prescribed range, another control system alarm is produced indicating the MBR system may be experiencing physical or control problems. Excessively high or low values of the calculated CFP may also be indicative of possible existence of extra cellular substances or other system, anomalies which may cause the system operator or the present control system to initiate other system control actions.

Through monitoring the TMP aod/or the CFP, the present control system alerts the system operator of operating conditions that may be indicative of poor MBR system performance. The lower limit setpoint is a control system variable or parameter that is based on membrane age, MLSS and general type or conditions of the wastewater. The CFP and TMP setpotnts or prescribed ranges are preferably established based on design of the MBR system and adjusted based on historical operation of the wastewater treatment plant or similar experiences.

A more advanced embodiment of the present control system is based, on the MBR flux. In this embodiment, the temperature; the permeate flow rate out of membrane; the pressures of the sludge flow in and out of the membrane; the pressure of the permeate flow out of the membrane are measured and the Trans Membrane Pressure (IMP); Temperature Correction Coefficient (Kit); MBR flux (Fx); and Membrane Conductivity (Fxc) are calculated as set forth below;

Fx=Fₚ/M Area (3)

Fxc—[Fx*Kt*2]/TMP (4)

The corrected MBR flux or Membrane Conductivity (Fxc) is then compared against a prescribed setpoint or range, if the or Membrane Conductivity (Fxc) is lower than die lower limit setpoint or falls below the prescribed range, the MBR system is commanded to initiate the membrane cleaning cycle. By controlling the initiation of membrane cleaning cycle the present control system maintains overall good membrane performance white reducing the need for membrane cleaning to times only when, required as determined based on actual operating conditions of the MBR system. Hie lower limit setpoint is a control system variable or parameter that is based on membrane age, MLSS and general type or conditions of the wastewater. Also, unexpected changes or variances in the corrected MBR flux or Membrane Conductivity can be monitored and linked to various control system alarms as such variances may be indicative of possible excretion of extra cellular substances which may cause the system operator or the present control system to initiate other system control actions.

In addition to monitoring the membrane system conductivity. Fxc, as a control parameter, it is also useful to monitor membrane permeate flux, and not in ratio to TMP. While it is desirable to maintain a high permeate flux to obtain high productivity per unit of membrane investment, it is also known that exceeding a certain value in membrane flux (i.e. the critical flux) can cause increased membrane fouling. The present control system allows for constraining the permeate flux by direct control of either permeate flow, flow into the biological basin, or both, despite fluctuations in the influent wastewater flow to die treatment system. This control feature or aspect requires allowance of excess volume in the treatment tanks, either in a separate tank called the equalization tank upstream of the biological treatment tank, or with, excess volume in the biological tank and membrane tanks, or a combination of all three. Liquid levels can then be varied in these tanks within certain limits set by the equipment design, to allow for independent control, for a period of time, of the tank influent flows and permeate flow. This approach may be termed “smart equalization” meaning dynamic control of system equalization effect to maintain desired, system parameters (e.g., membrane permeate flux) within specific constraints under most operating periods.

The empirically determined Temperature Correction Coefficients (Kt) are a function of the measured temperature and set forth in Table 2

TABLE 2
Temperature Correction Coefficient (Kt)

| ° C. | Kt |
|---|---|
| 0 | 2.003 |
| 1 | 1.934 |
| 2 | 1.870 |
| 3 | 1.808 |
| 4 | 1.751 |
| 5 | 1.696 |
| 6 | 1.645 |
| 7 | 1.596 |
| 8 | 1.549 |
| 9 | 1.505 |
| 10 | 1.463 |
| 11 | 1.422 |
| 12 | 1.383 |
| 13 | 1.346 |
| 14 | 1.311 |
| 15 | 1.278 |
| 16 | 1.245 |
| 17 | 1.214 |
| 18 | 1.184 |
| 19 | 1.153 |
| 20 | 1.127 |
| 21 | 1.099 |
| 22 | 1.073 |
| 23 | 1.048 |
| 24 | 1.022 |
| 25 | 1.000 |
| 26 | 0.977 |
| 27 | 0.955 |
| 28 | 0.934 |
| 29 | 0.913 |
| 30 | 0.893 |
| 31 | 0.875 |
| 32 | 0.860 |
| 33 | 0.839 |
| 34 | 0.822 |
| 35 | 0.816 |
| 36 | 0.788 |
| 37 | 0.773 |
| 38 | 0.759 |
| 39 | 0.744 |
| 40 | 0.730 |
| 41 | 0.717 |
| 42 | 0.703 |
| 43 | 0.691 |
| 44 | 0.678 |
| 45 | 0.667 |
| 46 | 0.656 |
| 47 | 0.644 − |
| 48 | 0.634 |
| 49 | 0.624 |
| 50 | 0.612 |
| 51 | 0.603 |
| 52 | 0.594 |
| 53 | 0.585 |
| 54 | 0.575 |
| 55 | 0.566 |
| 56 | 0.557 |
| 57 | 0.549 |
| 58 | 0.541 |
| 59 | 0.533 |
| 60 | 0.525 |
| 61 | 0.517 |
| 62 | 0.509 |
| 63 | 0.502 |
| 64 | 0.495 |
| 65 | 0.488 |
| 66 | 0.482 |
| 67 | 0.471 |
| 68 | 0.468 |
| 69 | 0.461 |
| 70 | 0.454 |
| 71 | 0.449 |
| 72 | 0.442 |
| 73 | 0.436 |
| 74 | 0.431 |
| 75 | 0.426 |
| 76 | 0.420 |
| 77 | 0.414 |
| 78 | 0.409 |
| 79 | 0.404 |
| 80 | 0.398 |
| 81 | 0.393 |
| 82 | 0.388 |
| 83 | 0.385 |
| 84 | 0.380 |
| 85 | 0.375 |
| 86 | 0.371 |
| 87 | 0.366 |
| 88 | 0.362 |
| 89 | 0.357 |
| 90 | 0.354 |
| 91 | 0.349 |
| 92 | 0.347 |
| 93 | 0.342 |
| 94 | 0.339 |
| 95 | 0.334 |
| 96 | 0.331 |
| 97 | 0.327 |
| 98 | 0.324 |
| 99 | 0.320 |

In still another embodiment of the present control system, the microprocessor based controller uses an estimated parameter referred to as Oxygen Uptake Rate (OUR) as a primary governing input and compared against a setpoint or prescribed range. If the estimated OUR is above the prescribed range, it may indicate that the wastewater contains a high levels of organic load which is often associated with increased membrane fouling in an MBR based wastewater treatment system. In this situation, the controller generates a signal to reduce the MBR flux. Reducing MBR flux during periods of high organic loads (i.e. high OUR) should reduce membrane fouling tendency. Controlling the MBR flux can best be achieved by adjusting the MBR pump flow rate and control valves, including the back pressure valves. In addition, in response to the high measured OUR the present control system reduces the influent flow rate into the biological basin if an appropriate equalization tank-volume is available upstream. Alternatively, the control system can modulate the flow rate of wastewater source flows or influent on a temporary basis to limit the OUR to a maximum value, providing further means to avoid conditions that may cause membrane fouling.

Estimating or calculating the Oxygen Uptake Rate (OUR) is preferably accomplished using techniques described in one or more prior art publications. In the preferred embodiments, the estimated OUR is based on a number of other system parameters including the measured dissolved oxygen (DO) level, the change In DO level as a function of time, the flow rate (Q) of air or high purify oxygen to the aeration basin, the basin volume (V), as well as the empirically known parameters of DO level at saturation and calculated values of the mass transfer coefficients K_{L}a. The general, continuous equation that describes the change in dissolved oxygen (DO) as a function of time (i.e. DO evolution) in a completely mixed reactor is represented as:

$$\frac{d DO}{d t} = \frac{Q}{V} \cdot ( {DO}_{i n} - DO ) + {K}_{L} a \cdot ( {DO}_{sat} - DO ) - OUR$$

where: Q is air/oxygen flow; V is aeration basin volume, DOᵢₙ is the dissolved oxygen level of the influent and DOₛₐₜ is the dissolved oxygen level at saturation, and K_{L}a is the mass transfer coefficient. The specific mathematical models used to describe the estimation and/or calculation of K_{L}a and OUR are described in various technical publications and will not be repeated here. While methods of determining actual biological basin OUR are preferred, other means can be employed. These means may include use of separate external respirometer systems to measure OUR in parallel to the main basin, or online measurements of Influent BOD, COD, TOC, or other analytical means of determining oxidizable contaminants that cause oxygen demand in biological treatment, combined with appropriate calculation models to estimate the likely OUR given, these contaminant concentrations. Furthermore, measured or estimated OUR, and/or measured values of organic load (e.g. BOD or COD), may be combined with measured MLSS levels and volumes in system tanks to estimate current system food to microorganism ratio (F/M ratio), which represents another useful control parameter. Similar control techniques or means to those described above for limiting peak OUR may be used to limit peak system F/M under high loads, since operation at elevated F/M ratio may be associated with increased membrane fouling.

### Additional-MBR Control Strategies

One aspect of the present MBR control strategy is centered on taking actions based on the membrane filtration conductivity or permeability (Fxc). The calculated Fcx is compared against a desired range of acceptable Fxc values for the particular MBR system. If the calculated Fxc is outside the desired Fxc range then the mixing energy input (Wm) is either increased or decreased to maintain the membrane conductivity or Fcx within the desired range. Generally speaking, too high of a mixing energy input wastes energy, whereas too low of a level, of mixing energy is often inadequate to maintain membrane conductivity. The mixing energy input is adjusted by varying the intensity of mechanical energy input (e.g. air scour blowers, pumps, motor drives) in a continuous fashion, and/or by adjusting MBR cycle times. If adjusting the mixing energy is inadequate to maintain the membrane conductivity above the lower level of the membrane conductivity range, then the MBR cleaning cycle is initiated.

Alternatively, one can also increase or decrease membrane tank recirculation rate, Fs, to maintain membrane conductivity in desired range. It is important to keep in mind that too high of a recirculation rate (Fs) wastes energy, whereas too low of a recirculation rate allows membrane tank TBS to go too high which adversely affects membrane flux and membrane fouling. To adjust the recirculation, rate, one simply varies or adjusts the recirculation pump or control valves in the intake and recirculation conduits. The lower limit or lower end of the Membrane Conductivity (Fcx) range is preferably determined with reference to membrane age, MLSS values of the wastewater in the influent or biological basin, and the type of wastewater. Unexpected changes can also indicate excretion of extra cellular substances (EPS), so can lead or other control actions.

Another aspect of die present MBR control strategy is centered on taking actions based on the calculated F/M Ratio or estimated OUR levels. Calculation of the F/M Ratio is based on measurements or estimates of BOD, COD, TOC, MLSS, and basin or tank levels. In one embodiment, the calculated F/M Ratio is compared against a desired setpoint or limit of F/M Ratio for the particular MBR system. If the calculated F/M Ratio is too high, the control system reduces the flow into biological basin, F_{b}, within constraints of available equalization volume in equalization tank by adjusting the control valves and/or pumps controlling the flow from equalization tank. Too high of a calculated F/M Ratio increases the risk of inadequate treatment and membrane fouling as it has been found that high organic loadings in the aeration or biological basin increases the tendency for membrane fouling.

In another embodiment, the estimated OUR is compared against a desired setpoint or high limit of OUR for the particular MBR system. If the OUR is too high, the oxygen demand may exceed the aeration system capacity, which can lead to low levels of dissolved oxygen and/or inadequate treatment, which in turn, increases membrane fouling. In such situations, the present control system reduces the flow into biological basin, F_{b}, by adjusting the control valves and/or pumps controlling the flow from equalization, tank.

Alternatively, for either of the above described embodiments (i.e. F/M Ratio control strategy and OUR control strategy), it is possible for the control system to adjust the prescribed ranges or setpoints for the calculated membrane flux during periods of high organic loading based on the measured or estimated parameters associated with organic loading.

From the foregoing, it should be appreciated that the present invention thus provides a method and system, for the advanced control of wastewater treatment plants. Having membrane bioreactors. While the invention herein disclosed has been described by means of specific embodiments and processes or control techniques associated therewith, numerous modifications and variations can be made thereto by those skilled in the art without departing from the scope of the invention as set forth in the claims or sacrificing all of its features and advantages.

1. An advanced control system for a wastewater treatment plant comprising:
An advanced control system for a wastewater treatment plant comprising:
a membrane bioreactor (MBR) system comprising a plurality of membrane modules or units; one or more pumps and valves for controlling the flow of wastewater through the membrane modules or units; and a plurality of sensors for measuring one or more of MBR measured parameters selected from the group consisting of temperature of the stream flowing into the membrane modules or units; the flow rate of the stream into the membrane modules or units; the flow rate of the sludge stream out of the membrane modules or units; the flow rate of the permeate stream out of membrane modules or units; pressure of the flow into the membrane modules or units; pressure of the flow out of the membrane modules or units; the pressure of the permeate flow out of the membrane modules or units;
one or more microprocessor based controllers that: (i) receives signals corresponding to the measured MBR parameters from the plurality of sensors; (ii) calculates one or more MBR calculated parameters including Oxygen Uptake Rate (OUR) in an upstream biological basin or Membrane Conductivity (Fxc); (iii) compares one or more calculated MBR parameters to prescribed setpoints or desired ranges; and (iv) sends control signals to the one or more pumps or to one or more valves to adjust the flows through the MBR system or to adjust the influent flow to the upstream biological basin in response thereto.

2. The advanced control system of claim 1 wherein the MBR system is an external or cross-flow MBR system.

3. The advanced control system of claim 1 wherein the MBR system is an immersed or low pressure MBR system.

4. The advanced control system of claim 1 wherein the microprocessor based controllers further generates a signal that activates an alarm to notify the wastewater treatment plant operators when the one or more calculated MBR parameters, the Membrane Conductivity (Fxc); or the OUR are outside the prescribed setpoints or desired ranges.

5. The advanced control system of claim 1 wherein the OUR is estimated or calculated using one or more of the following parameters: dissolved oxygen levels: change in dissolved oxygen as a function of time; flow of air/oxygen; aeration basin volume; mass transfer coefficient, and measures of oxidizable contaminants.

6. The advanced control system of claim 5 wherein the OUR is estimated or calculated using the following equation:
$$\frac{d DO}{d t} = \frac{Q}{V} \cdot ( {DO}_{i n} - DO ) + {K}_{{L}^{G}} \cdot ( {DO}_{sat} - DO ) - OUR$$
where DO is the dissolved oxygen level; dDO/dt is the change in dissolved oxygen as a function of time; Q is air/oxygen flow; Fis aeration basin volume. DOᵢₙ is the dissolved oxygen level of the influent; DOₛₐₜ is the dissolved oxygen level at saturation, and K_{L}a is the ascertained mass transfer coefficient.

7. An advanced control system for a wastewater treatment plant comprising:
a membrane bioreactor (MBR) system comprising a plurality of membrane modules or units; one or more pumps and valves for controlling the flow of wastewater through the membrane modules or units; and a plurality of sensors for measuring one or more of MBR measured parameters selected from the group consisting of temperature of the stream flowing into the membrane modules or units; the flow rate of the stream into the membrane modules or units; the flow rate of the sludge stream out of the membrane modules or units; the flow rate of the permeate stream out of membrane modules or units; pressure of the flow into the membrane modules or units; pressure of the flow out of the membrane modules or units; the pressure of the permeate flow out of the membrane modules or units;
one or more microprocessor based controllers that: (i) receives signals corresponding to the measured MBR parameters from the plurality of sensors; (ii) calculates Membrane Conductivity (Fxc); (iii) compares the calculated membrane conductivity (Fxc) to prescribed setpoints; and (iv) initiates a membrane cleaning cycle when membrane conductivity falls below minimum setpoint.

8. The advanced control system of claim 7 wherein the MBR system is an external or cross-flow MBR system.

9. The advanced control system of claim 7 wherein the MBR system is an immersed or low pressure MBR system.

10. An advanced control system for a wastewater treatment plant comprising:
an aeration or biological basin;
an membrane bioreactor (MBR) system comprising one or more membrane modules; one or more pumps and valves for controlling the flow of wastewater through the membrane modules; and
one or more microprocessor based controllers that: (i) receives signals from a plurality of sensors associated with the aeration basin including a dissolved oxygen (DO) probe; (ii) calculates or estimates the Oxygen Uptake Rate (OUR) in the aeration basin; (iii) compares the OUR to a prescribed setpoint or desired range; and (iv) sends control signals to the one or more pumps or valves within the MBR system to adjust the flow of wastewater through the membrane modules or adjusts the influent flow to the aeration or biological basin in response thereto.

11. The advanced control system of claim 10 wherein the MBR system is an external or cross-flow MBR system.

12. The advanced control system of claim 10 wherein the MBR system is an immersed or low pressure MBR system.

13. The advanced control system of claim 10 wherein the OUR is estimated or calculated using one or more of the following parameters: dissolved oxygen levels; change in dissolved oxygen as a function of time; flow of air/oxygen; aeration basin volume; mass transfer coefficient, and measures of oxidizable contaminants.

14. The advanced control system of claim 13 wherein the OUR is estimated or calculated using the following equation:
$$\frac{d DO}{d t} = \frac{Q}{V} \cdot ( {DO}_{i n} - DO ) + {K}_{{L}^{G}} \cdot ( {DO}_{sat} - DO ) - OUR$$
where DO is the dissolved oxygen level; dDO/dt is the change in dissolved oxygen as a function of time; Q is air/oxygen flow; V is aeration basin volume, DOᵢₙ is the dissolved oxygen level of the influent: DOₛₐₜ is the dissolved oxygen level at saturation, and K_{L}a is the ascertained mass transfer coefficient.
